(19) United States
(12) Patent Application Publication
(10) Pub. No.: US 2015/0261310 A1
(43) Pub. Date: Sep. 17, 2015

(54) ONE-DIMENSIONAL INPUT SYSTEM AND METHOD

(71) Applicant: WHIRLSCAPE, INC., Toronto (CA)

(72) Inventors: William Spencer Walmsley, Toronto (CA); William Xavier Snelgrove, Toronto (CA); Khai Nhut Truong, Atlanta, GA (US); Severin Ovila Ambroise Smith, Montreal (CA)

(21) Appl. No.: 14/418,426

(22) PCT Filed: Jul. 30, 2013
(86) PCT No.: PCT/CA2013/050588

§ 371 Date: Jan. 29, 2015

Related U.S. Application Data
(60) Provisional application No. 61/678,331, filed on Aug. 1, 2012.
(60) Provisional application No. 61/812,105, filed on Apr. 15, 2013.

(51) Int. Cl. G06F 3/023; G06F 3/041; G06F 3/0488; G06F 1/16; G06F 3/0482

(52) U.S. Cl. CPC G06F 3/0233; G06F 1/1626; G06F 1/1694; G06F 3/0237; G06F 3/0482; G06F 3/04883; G06F 3/04886; G06F 3/0412; G06F 2200/1612; G06F 2200/1614; G06F 2200/1636; G06F 2200/1637; G06F 2203/04101; G06F 2203/04106; G06F 2203/04808

(57) ABSTRACT

A one-dimensional input system is provided. The input system comprises a plurality of characters arranged on a single dimension. User input along the dimension is continuously disambiguated. The characters may be arranged based on factors including motor efficiency, optimization of disambiguation and learnability. A touchscreen interface of the one-dimensional input system is provided. A gesture-based interface of the one-dimensional input system is also provided.

### CROSS REFERENCE

This application claims priority from U.S. Patent Application No. 61/678,331 filed Aug. 1, 2012 and U.S. Patent Application No. 61/812,105 filed Apr. 15, 2013, both of which are incorporated by reference herein.

### TECHNICAL FIELD

The following relates generally to a computer-implemented input system and method, and more specifically in embodiments to a one-dimensional input system and method.

### BACKGROUND

Touchscreen computers are becoming ubiquitous. Generally, touchscreen computers, at least to some extent and in certain use cases, dedicate a portion of the touchscreen display to a user input system, such as a touchscreen keyboard. However, these input systems tend to occupy a significant portion of the display. In lay terms, touchscreen input systems occupy a substantial amount of screen “real estate” that could otherwise be used to enhance the user experience.

Meanwhile, wearable computers are finally becoming commercially viable. However, there is no one particularly intuitive approach to enable users to provide input to these devices. In some cases, it is not realistic to implement a physical keyboard, for example, on a wearable computer such as a watch or pair of glasses, as the keyboard would be unrealistically large and cumbersome.

Further, anecdotal evidence suggests that users divert attention away from the real world in favour of providing input to their mobile computer. Examples include text messaging while walking, which generally involves a user not looking at where they are walking.

There is also sometimes a barrier to providing input to a mobile computer when one or both of the user's hands are occupied with another activity. Examples are biking, driving, or eating. In these cases, mobile interaction techniques that require both hands cannot be used.

In many cases, users are incapable of entering input precisely due to reduced dexterity or coordination. This may be due to environmental or occupational constraints, for example in military, firefighting or surgical scenarios. Alternatively, reduced dexterity may be a consequence of temporary or permanent physical impairment, for instance caused by paralysis.

### SUMMARY

In one aspect, a system for enabling a user to provide input to a computer is provided, the system comprising: (a) an input unit operable to obtain one or more user input from said user and map each said user input to a coordinate along a one-dimensional input space; and (b) a disambiguation unit operable to apply continuous disambiguation along said one-dimensional input space to generate an output corresponding to the user input.

In another aspect, a method for enabling a user to provide input to a computer is provided, the method comprising: (a) obtaining one or more user input from said user; (b) mapping each said user input to a coordinate along a one-dimensional input space; and (c) generating an output corresponding to the user input by applying, using one or more processors, continuous disambiguation along said one-dimensional input space.

### DESCRIPTION OF THE DRAWINGS

Features will become more apparent in the following detailed description in which reference is made to the appended drawings wherein:

FIG. 1 illustrates a one-dimensional input system;

FIG. 2 illustrates movement along a single dimension in a motion-sensing interaction scenario;

FIG. 3 illustrates a plurality of gestures for use in a motion-sensing interaction scenario;

FIG. 4 illustrates letter interchangeability in a particular corpus;

FIG. 5 illustrates a miss model distribution for a particular style of interaction;

FIG. 6 illustrates a predictive interchangeability weighting in a particular corpus;

FIG. 7 illustrates bigram frequencies in a particular corpus;

FIG. 8 illustrates a touchscreen interface representation of a one-dimensional textual input system;

FIG. 9 illustrates another touchscreen interface representation of a one-dimensional input system;

FIG. 10 illustrates variants of a watch suitable for use with the one-dimensional input system;

FIG. 11 illustrates variants of another watch suitable for use with the one-dimensional input system;

FIG. 12 illustrates a watch and sensor suitable for use with the one-dimensional input system;

FIG. 13 illustrates variants of yet another watch suitable for use with the one-dimensional input system;

FIG. 14 illustrates a ring suitable for use with the one-dimensional input system; and

FIG. 15 illustrates a touchscreen interface for the one-dimensional input system showing two methods of text entry.

### DETAILED DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any unit, module, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

While the following describes a one-dimensional input system comprising the 26 characters of the English alphabet, with some embodiments incorporating the numbers 0 to 9 and various additional symbol characters, it should be understood that the following teachings and principles apply for any other form of structured input, such as a language, inclusive of punctuation, numbering, symbols, emoticons or other possible inputs.

In an example embodiment, the one-dimensional input system provides a plurality of characters disposed along one dimension, wherein one-dimensional implies an arrangement along a continuous dimension. The continuous dimension may be a line, arc, circle, spiral or other shape wherein each of the characters is adjacent to two other characters, except optionally two characters that may be considered terminal characters (i.e., the first and last character) which may be at terminating positions adjacent to only one other character, though they could be adjacent to one another in a circular character arrangement. The continuous dimension may further include a separated plurality of segments whereby each segment functions as a continuous dimension as described above. It will be appreciated that the use of the term “one-dimensional” includes the case of a dimension parameterized along a one-dimensional manifold, thus permitting non-linear dimensions as coordinate slices of higher-order dimensions. For example, in the case of a two-dimensional touchscreen interaction surface, a curved dimension, which may even form a closed loop, may be considered to be “one-dimensional” in this sense. In another example, a continuous S-shaped or continuous repeating curve may be used.

A disambiguation unit provides continuous (ungrouped) disambiguation of a user's input to the system. In other words, the specific points along the dimension selected by the user are relevant to determine the character sequence the user had intended to enter. This can be contrasted with discrete (grouped) disambiguation, in which the input is quantized to a grouping of characters such that characters within a discrete grouping are assumed to have fixed input likelihoods upon user selection of the grouping prior to disambiguation, and/or such that characters outside the discrete grouping are assumed to have an input likelihood of zero.

The term “disambiguation” is used herein to refer to the mitigation of ambiguity that may arise with imprecise user input, in which an alternate input may instead have been intended, an input given but not intended, an input erroneously omitted, inputs have been incorrectly transposed (i.e., input out of intended order), an input sequence provided incompletely, or combinations of the foregoing. At least some aspects of this process may also be commonly referred to “auto-correction”, “auto-completion”, or “auto-prediction”.

In particular embodiments, the plurality of characters in the one-dimensional input system may further be arranged relative to one another to optimize against ambiguity.

Further, a system and method for enabling interaction with a one-dimensional input system is provided. In various embodiments, a user can interact with the one-dimensional input system by a plurality of predefined gestures or other actions. The gestures or actions may comprise gestures (including flick and swipe gestures) performed on a touchscreen interface (including the region of the touchscreen interface upon which a visual representation of the input system is shown, as well as other regions of the touchscreen interface which do not appear to a user to be allocated to the input system), gestures performed using peripheral buttons of and/or movements sensed by a handheld device, gestures performed using a wearable device, and/or actions including eye movement, sound or breathing or any other mechanism for providing a quantitative measurement on a single dimension.

In embodiments, the one-dimensional input system is operable to obtain input provided along a single dimension. However, in aspects, additional information gathered in respect of user input along other dimensions to the single dimension may be used to augment disambiguation, provide support for additional actions and gestures that may serve an auxiliary purpose, or both. For example, if a user vertically misses an input target from a horizontal arrangement of input targets, the system may gather information that a miss was made, and perhaps the degree (distance) of the miss, and correlate the gathered information to historical or preconfigured information that vertical misses in proximity of that input region more often correspond to a specific input target. As a result, the system may more highly weight the likelihood of the user having intended to select that specific input target.

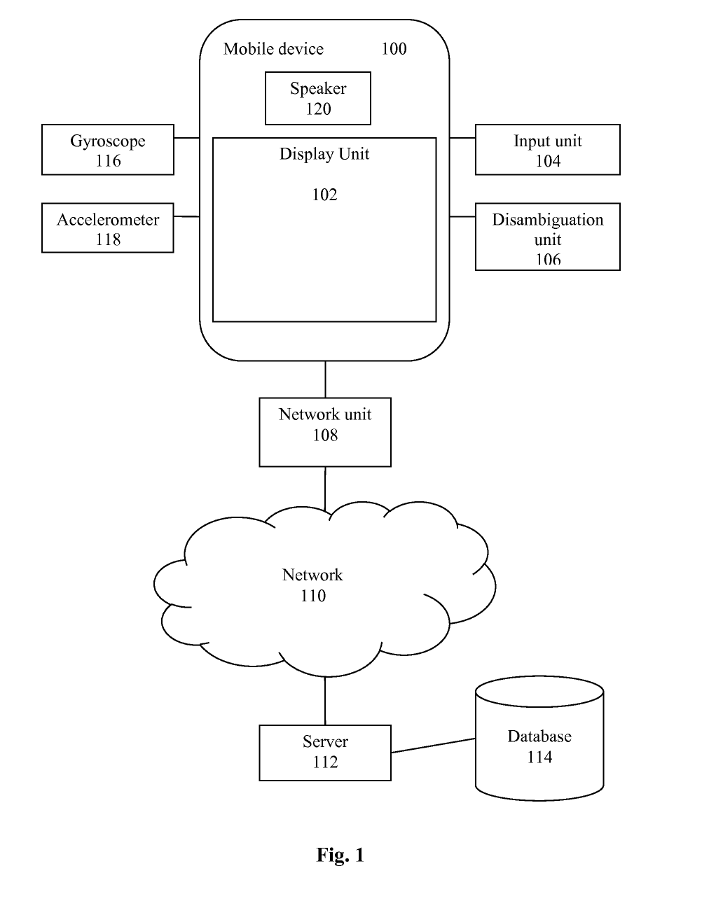

An example of a mobile device providing a one-dimensional input system is shown in FIG. 1. The mobile device (100) comprises a display unit (102). The display unit may, for example, comprise a touchscreen input/output interface. In this example, an input unit (104) is linked to the touchscreen interface to process user commands made using the screen, including presses, taps and gesture movements. The input unit obtains the user input and maps the user input to a coordinate along a one-dimensional input space. In this example, the one-dimensional input system may be considered to implement a one-dimensional virtual keyboard. The input is provided to the disambiguation unit (106), which performs continuous disambiguation to generate an output.

The mobile device may further comprise a network unit (108) providing cellular, wifi or Bluetooth™ functionality, enabling network access to a network (110), such as the cloud. A central or distributed server (112) may be connected to the cloud as a central repository. The server may be linked to a database (114) for storing a dictionary. Further, the input unit may be configured to accept a command to enable a user to view, modify, export and backup the user's dictionary to the database. Further still, a web interface to the server, with login capability, may be provided for enabling each user to view, modify, export and backup the user's dictionary to the database so that the user can perform such commands from the mobile device or another computer. These functions could further be automated, such as by being handled by a “cloud sync” service.

In an alternative embodiment, the disambiguation unit may be located in the cloud, wherein the input unit collects input from the user and communicates the input remotely to the disambiguation unit for disambiguation.

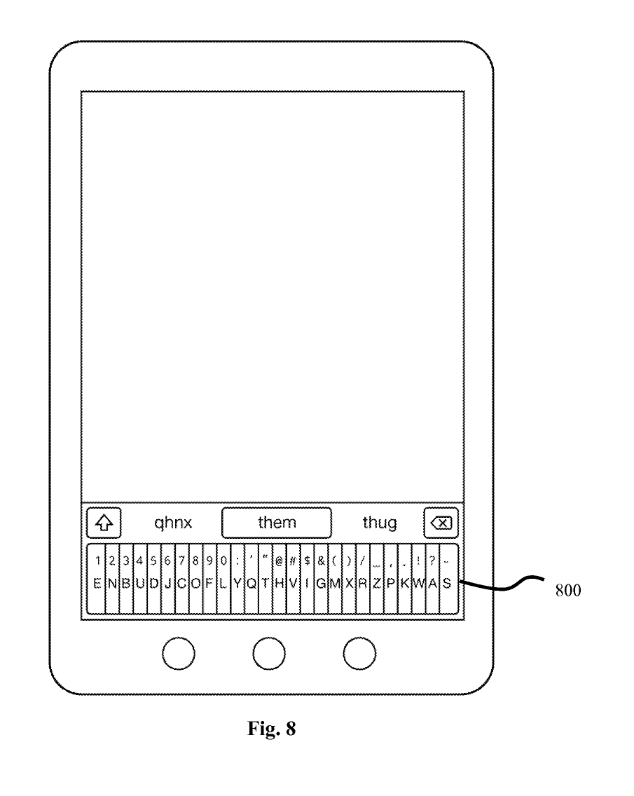

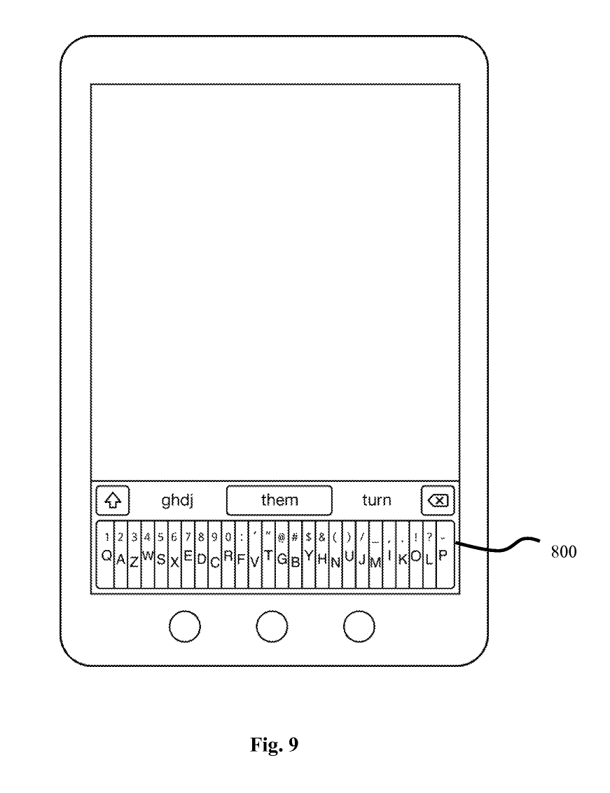

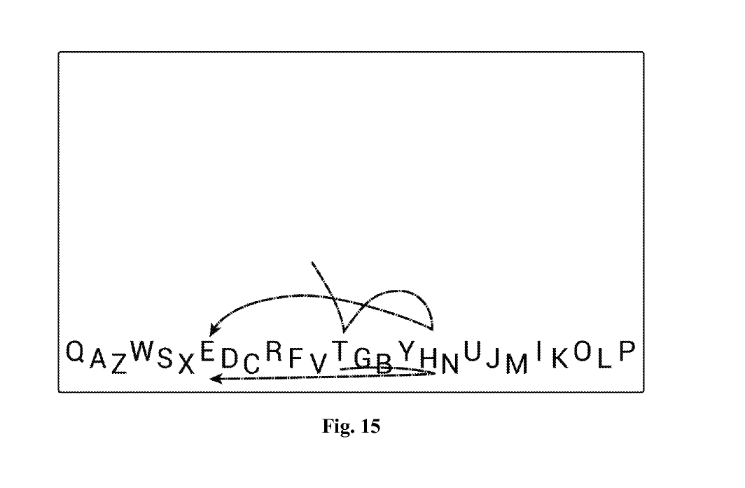

Exemplary one-dimensional input systems are shown in a touchscreen in FIGS. 8 and 9. Characters can be selected by, for example, tapping or sliding a finger/thumb in a continuous motion on the touchscreen along the input region (800). Touch deviations in the direction perpendicular to the axis of the character layout may be used to indicate selection of characters, including in the case of continuous sliding entry. In the case of continuous sliding entry, spatial or temporal information about dwelling at various locations during the continuous entry may also be used to indicate likely character selection events. This is shown, for example, in FIG. 15 by the set of distinct movements (illustrated as arcs above the characters in FIG. 15) beginning prior to selecting letter “T” followed by letter “H” and finally letter “E”. Further gestures, such as swipes or flicks along the touchscreen (whether within or outside of the input region (800)) in any given direction, long presses on the touchscreen, or shape-based gestures, may be used to indicate the triggering of actions including changing input modes, entering spaces or special characters, performing deletion of one or more letters or words, carriage returns, or change of letter case. Changing input modes may correspond to entering numbers rather than alphabetic characters, or could additionally cause the input unit to display an alternate virtual input device, such as a more traditional multi-dimensional keyboard. Additionally, the user may perform a gesture to adjust the dimensions of the virtual input device, such as by elongating or heightening the virtual input device as desired by the user. In this latter implementation, the height of the virtual input device may enable the input system to obtain additional information in respect of user input corresponding to a secondary (e.g., height) dimension, in addition to information in respect of user input corresponding to the primary dimension. In this way, the additional information may constitute a feature to be used as input to the input system, where such feature may be given a suitable weight by the input system.

It should be understood that while the figures show a touchscreen mobile phone, the input unit does not require a display or touchscreen. The one-dimensional input system may be implemented in any device operable to obtain user input that can be mapped to a single dimension. This input may comprise any one or more of: a movement of a body part (whether mapped as a linear or angular position, either as a relative position between body parts or as an absolute position relative to a fixed reference frame, or a parameterised complex gesture such as a wave, punch, or full body motion, or as a pointing gesture used to point at and select desired inputs, or as a muscle tension, for example; and using a body party such as a finger, hand, arm, foot, thigh, tongue, or head, for example), movement of a tangible object, sound (whether mapped by a volume, pitch or duration, for example), eye movement (such as mapping the position of the pupil from left to right or up to down or around a circle/oval, for example), pressure (whether varied by the user shifting weight while sitting in a force-sensitive chair, or by the application of force to a compressible measuring device), breath (whether mapped by pressure, duration or inhalation/exhalation, for example), manipulation of a control device (whether mapped by position, orientation, proximity, movement of a joystick/trackball/scroll wheel, or a position amongst a set of buttons, for example), a series of actions conveyed with variable or rhythmic durations or timing, or any other quantitative measure. Additionally, the device may function by acting as a scanning keyboard whereby possible inputs are automatically cycled through, with the user providing a signal input signal to indicate when to enter a given letter. In implementations where one or more additional spatial input dimensions are available, further aspects of the touchscreen embodiment may also be applied, for example including continuous sliding entry or a broader set of directional gestures. This is shown, for example, in FIG. 15 by a continuous sliding motion from letter “T” to letter “H” and finally to letter “E”.

The input unit may comprise or be linked to a device such as, for example, be a mobile phone or tablet (whether touchscreen or otherwise); an in-vehicle control such as a steering wheel, handlebar, flight stick, driving control, input console, or media centre, for example; a home entertainment system controller such as a remote control, game controller, natural gesture sensing hardware, or touch screen, for example; a presentation delivery device such as a handheld pointer, for example; a Braille display device (which may provide haptic feedback for selection of letters); a ring, glove, watch, bracelet, necklace, armband, pair of glasses, goggles, headband, hat, helmet, shoe, tie, fabric-based clothing accessory, or other clothing accessory, wearable accessory or jewellery item, for example; an industrial barcode reader; a communicator for rugged, emergency, military, search-and-rescue, medical, or surgical scenarios, for example; a writing implement such as a pen, pencil, marker, or stylus, for example; a touchpad such as a graphics tablet or trackpad; an assistive communication device for accessibility purposes; an input device mounted onto furniture, appliances, doorknobs, or walls, for example; a public display terminal such as an information kiosk, ATM, ABM, or advertising display, for example; a mobile device case or accessory; an e-book reader; a stress ball or other deformable object; a flexible, foldable, or telescoping device; a set of tangible devices with an input dimension defined by their absolute or relative positions or orientations, for example; a single device with multiple moving parts whereby an input dimension is defined by the relative positions or orientations of the parts; a tool or utensil such as a wrench, calculator, ruler, chopsticks; any other tangible object.

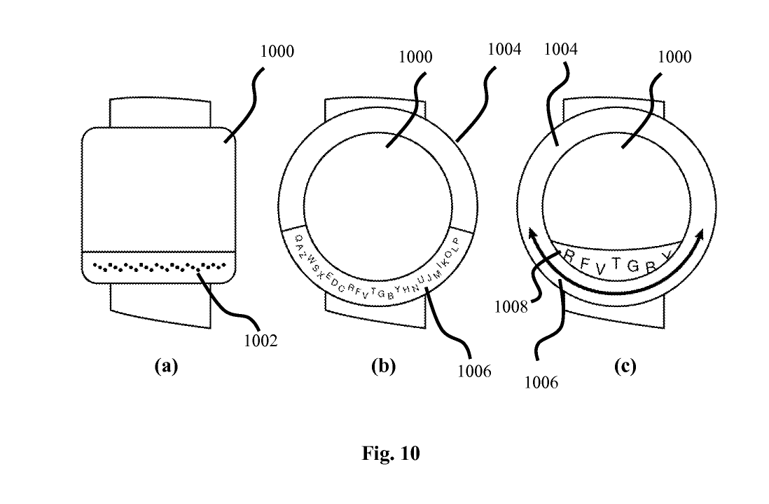

Certain specific examples of the foregoing are shown in FIGS. 10 to 15.

FIG. 10 shows an example of three watches comprising an input unit. The watches may further comprise the disambiguation unit or may be linked to a further computing device providing disambiguation. In FIG. 10(a), the watch face (1000) or a portion thereof comprises a touchscreen (1002) upon which the input unit may display a virtual input device. In FIG. 10(b), a portion (or all) of the bezel (1004) surrounding the watch face (1000) may comprise a touch sensor (1006), such as a capacitive strip, enabling the bezel (1004) to be used as the input device. In the example of FIG. 10(b), a plurality of characters may be printed statically upon the bezel. FIG. 10(c) shows a touch sensor (1006), such as a capacitive strip, on all (or a portion) of the bezel (1004) surrounding the watch face. In this example, the watch face may comprise a display screen (1008) that dynamically displays the selected characters whilst the bezel is being rotated.

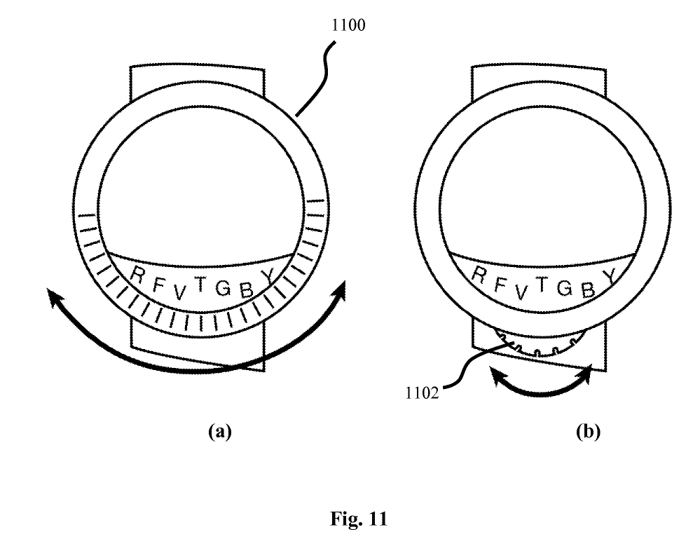

FIG. 11 shows another example of a watch, however in this example the watch comprises a mechanical input device. In FIG. 11(a), the watch has a mechanically rotating bezel (1100) that is used as the input device, while in FIG. 11(b), the watch comprises a scrollable (rotating) wheel (1102) that can be operated as the input device. In both cases, the watch face (1104) may comprise a display screen that dynamically displays the selected characters whilst the bezel (1100) or wheel (1102), as the case may be, is being rotated.

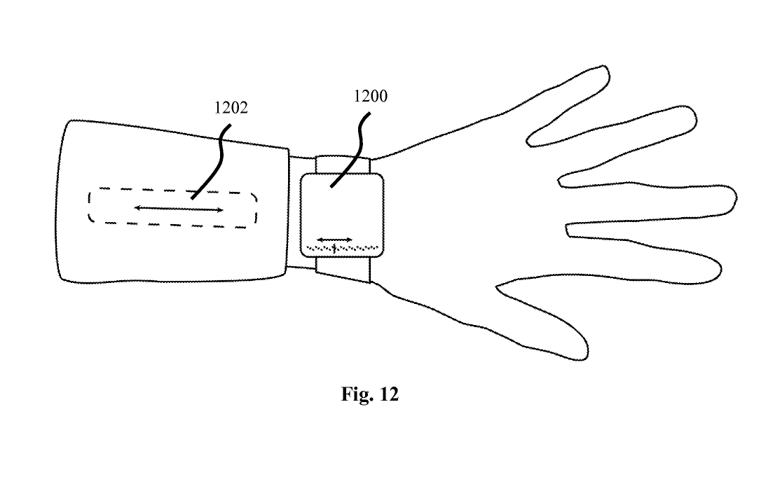

Another example of a watch is shown in FIG. 12. In this case, the watch (1200) may provide a display unit while the input unit is physically separate from the watch but linked thereto. In the example shown, the input unit is provided by a touch sensor (1202) woven into or disposed upon a fabric garment worn by the user. While the figure shows the sensor proximate the watch on the user's arm, it will be appreciated that the sensor could be disposed upon any wearable article.

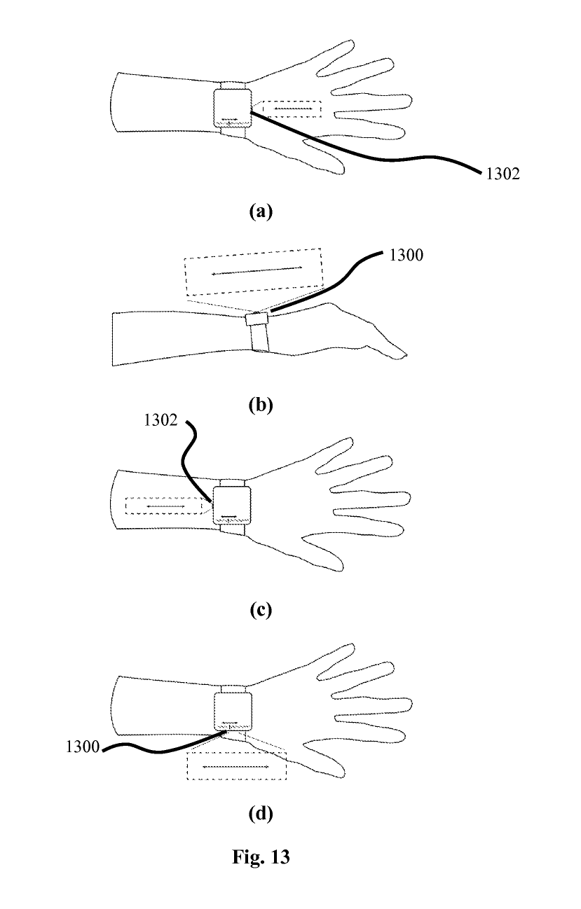

A further example of a watch is shown in FIG. 13. In this case, the watch comprises an input unit linked to one or more spatial sensors (1300) and/or optical sensors (1302), such as infrared or camera-based sensors. The sensors are configured to sense predetermined gestures performed proximate the location of the watch, such as floating interaction above the watch, gestures tapped onto the arm, back of the hand, or side of the hand.

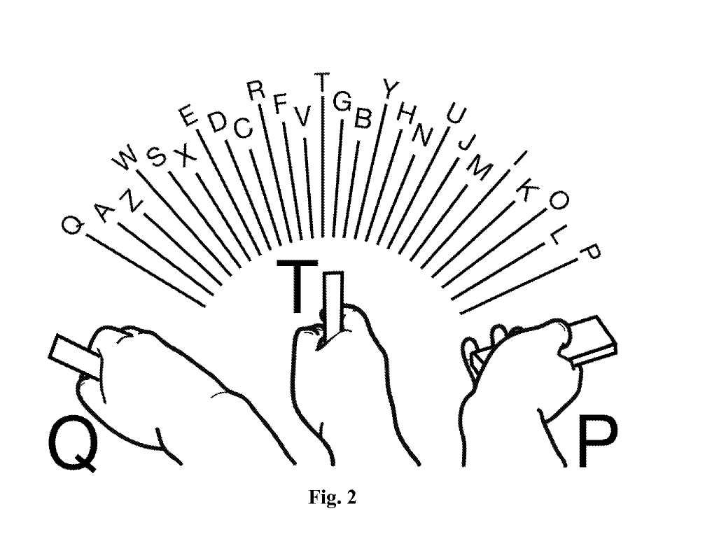

In another example of a watch, which may operate similarly to the input system shown in FIG. 2, the watch comprises an input unit linked to motion sensors, such as gyroscopes and/or accelerometers, enabling the watch to sense movements. In this case, it may be preferable to provide a further computing device to provide visual feedback to the user and/or for the watch to provide audio feedback to the user. Alternatively, the input unit may be provided by a further device, such as a ring or mobile phone for example, which is linked to the watch, with visual or audio feedback provided by the watch.

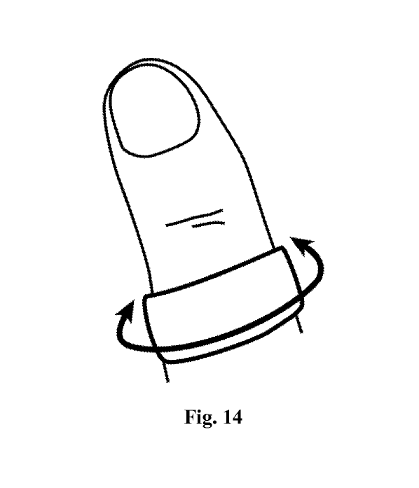

Another example of a wearable device operable with the one-dimensional input system is a ring, as shown in FIG. 14. An example of such a ring includes one which comprises a motion sensor operable to determine movement of a finger upon which a ring is worn, and to map such movement along at least the one dimension corresponding to that of the input system. Another example is a ring that is rotatable about a base (wherein the base abuts the wearer's finger and the outer surface of the ring freely rotates) such that the user can rotate the ring to cause input along the dimension defined by the rotation.

It will be appreciated that numerous further specific examples of wearable and non-wearable embodiments are contemplated herein.

The device may sense input dimensions using one or more of a plurality of sensor systems, or by a combination of sensor systems to enhance reliability of the detection of an input dimension. A plurality of sensor systems may also be used to detect different aspects of input, including both the primary input dimension and the set of auxiliary gestures that may need to be performed (for example, in the case of text entry, space, backspace, enter, shift, etc.). Such sensor systems may detect user touch input on the front, back, side, or edge of a device via resistive (either via a single variable resistor or by an array), capacitive (swept frequency capacitive sensing, capacitive sliders, or a capacitive sensor array), magnetic, optical sensors (frustrated total internal reflection (FTIR), camera sensing, or fibre optic cable), or piezoresistive/piezocapacitive/piezoelectric sensors or fabrics, for example; user distance and/or gesture measurement by laser rangefinder, infrared or ultrasound proximity sensor, camera sensing (especially by stereo camera, and/or augmented with structured light patterns) or other hands-free sensor; electroencephalography used to measure neural activity; electroencephalography to measure muscle movements; weight or pressure sensors, such as in a pressure-sensitive chair or floor; magnetometers; motion sensing sensors such as accelerometers, gyroscopes, and the combination thereof; microphones, geophones, or other auditory sensors, used to measure or detect sound patterns, pitches, durations, volumes, phases, or locations, via any sound-transmitting medium such as air, the human body, or a rigid surface, for example.

The device may provide tactile, haptic, audio, or visual feedback, for example, with real or simulated texture or ridges along a tactile region.

In a more specific example where the device is a wrist-worn device such as a watch, such a device may receive user input via one or more input modalities, including tapping/sliding/scrolling via a trackball, touch-sensitive strip, scroll wheel; tilting as measured by an accelerometer and/or gyroscope, as described below; tapping or gesturing on or near the arm, hand, or watch, as detected by one or more cameras, rangefinding sensors (e.g., infrared sensors), or magnetometers (in which case a user would mount a magnet on the tapping finger), or any combination thereof. Tapping and flicking gestures may be supported by other sensors such as an accelerometer or vibration-detecting piezoresistive/piezocapacitive/piezoelectric sensor, for example.

In a more specific example where the device is a foot-mounted device such as a shoe, the device may contain an accelerometer, gyroscope, magnetometer, or other motion or orientation sensor. Such a device may then measure any combination of foot tapping, sliding, pivoting, rocking, toe bending, or other motion-based gestures to provide selection of letters along a single dimension. For example, rotation of the foot about a pivot point may provide a single absolute angular input dimension, while tapping of the foot may indicate letter selection. Such a device may instead or also interact with sensing units in the floor to provide robust detection of gestures.

In a more specific example, the device may be a home entertainment system controller. For handheld or wearable controllers, existing input modalities may be leveraged to provide both one-dimensional input and support of auxiliary actions, such modalities including joysticks, direction pads, buttons, motion sensors such as accelerometers and/or gyroscopes, or spatial tracking of the controller. Alternatively, a handheld controller may be extended with other sensing techniques (as described previously) to provide one or more additional input modalities for typing.

Additionally, a system comprising the disambiguation unit, a communication unit applying suitable communication protocols, and arbitrary sensory systems may enable arbitrary human input dimensions to function as input.

The device may further be, for example, any movable device, including a handheld or wearable device, such as a device worn on a wrist or finger. For example, as shown in FIG. 1, a mobile device may comprise a gyroscope (116) and an accelerometer (118). The mobile device may further comprise a speaker (120) and a touchscreen input/output interface (shown as display unit 102). An input unit is linked to the mobile device or may be a component of the mobile device. The input unit interfaces with the touchscreen, gyroscope, accelerometer and speaker to enable a user to provide input to the mobile device via a plurality of predefined gestures. A disambiguation unit is linked to the input unit for providing disambiguation to user-entered input. The input unit analyzes movement sensed by the gyroscope and accelerometer to determine device orientation, including in jostling situations such as walking or even jogging.

In the example shown in FIG. 2, the single dimension corresponds to input rotating around an axis. However, it will be appreciated that the following principles apply to other embodiments of the one-dimensional input system, including those described above.

It has been found that, with a touchscreen or gesture-based system provided by the input unit, particular one-dimensional character layouts may be optimal. Furthermore, it has been found that a particular disambiguation method may be effective when applied by the disambiguation unit with the particular character layouts.

Two exemplary character layouts are illustrated in FIGS. 8 and 9 wherein orientation about a single axis is mapped to a one-dimensional character layout. The illustrated layouts enable a user to select a desired word or phrase by approximately selecting characters in the word or phrase.

In an example of the input unit displaying the character layout on a touchscreen, the input unit subsequently receives information regarding the points, or coordinates, at which the user presses to select characters. Based on the points, the disambiguation unit performs continuous disambiguation to disambiguate the characters and the phrase. Continuous disambiguation is in contrast to discrete disambiguation, in which, for example, consideration of which character is selected is interpreted based on the quantized grouping that the character lies within. In other words, although the one-dimensional input space may comprise a finite number of characters, continuous disambiguation may disambiguate user input based upon the specific points of the coordinates.

By applying the presently described continuous disambiguation, information comprising the point at which a character has been selected can be used to determine the likelihood of whether the user intended to select that character or another character. As the user enters the phrase, a corpus of text, or a combination of multiple corpora of text, such as the Corpus of Contemporary American English (COCA) and the set of all phrases historically entered by a user, for example, can be referenced to determine the most likely phrase or phrases that the user intended to enter.

The disambiguation unit applies continuous disambiguation to the input entered by the user. The input may comprise input provided on the touchscreen, by gestures, peripheral buttons or other methods.

In one embodiment, the disambiguation unit may apply a maximum a posteriori (MAP) disambiguation process. Given an entered word wₑₙₜ, the system outputs an estimated intended word wᵢₙₜ that under its model is most probable to have been desired by the user out of all hypothesized words w_{hypo}:

wᵢₙₜ=argmax_{w}_{_{hypo}}p(w_{hypo}/wₑₙₜ) (1)

p(w_{hypo}/wₑₙₜ) may be calculated in a Bayesian framework, combining a generative model of entered words given intended words (how users are expected to mistype), and a prior probability of intended words. By Bayes' rule:

$$p ( {w}_{hypo} \vert {w}_{ent} ) = \frac{p ( {w}_{ent} \vert {w}_{hypo} ) \cdot p ( {w}_{hypo} )}{p ( {w}_{ent} )} \qquad ( 2 )$$

The denominator p(wₑₙₜ) is a constant across hypothesis word w_{hypo}, so can be ignored in the maximization.

The prior term p(w_{hypo}) may be derived from word frequencies from a corpus. The generative term p(wₑₙₜ/w_{hypo}) may be approximated as the product of terms for each character, as in (3). The intended word is assumed to be the same length as the entered word, and so only hypothesized words that are the correct length may be considered.

$$p ( {w}_{ent} \vert {w}_{hypo} ) = {\prod }_{i = 1}^{len ( {w}_{hypo} )} p ( {c}_{ent}^{( i )} \vert {c}_{hypo}^{( i )} ) \qquad ( 3 )$$

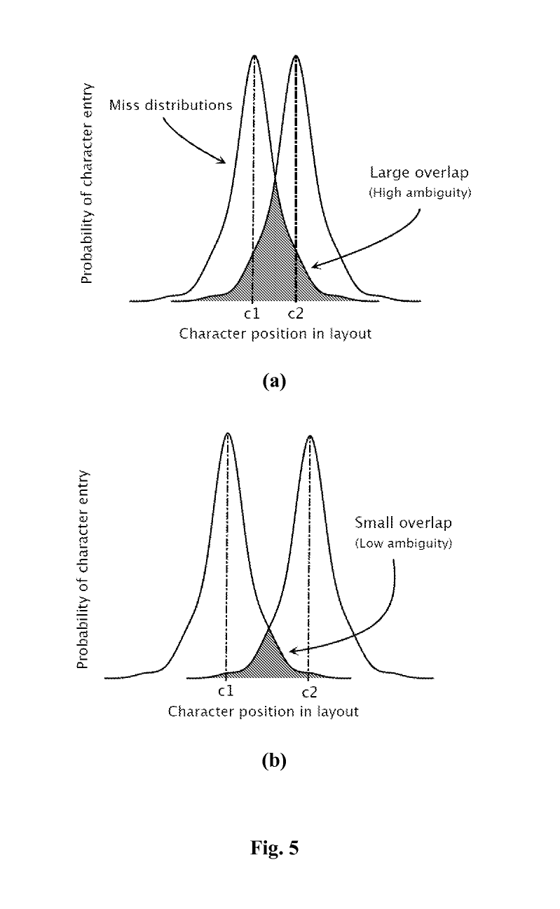

The notation c_{hypo}^{(I)} refers to the i^{th} character of the hypothesized word w_{hypo}. Here, (i) (i) the character-level “miss models” p(cₑₙₜ⁽ⁱ⁾/c_{hypo}⁽ⁱ⁾) may be determined empirically for any given input modality by analyzing user selection from an A-Z alphabetical character arrangement (for the English language), and may generally be approximated by a leptokurtic distribution centred around the intended letter, with a variance of 2 letters. A possible assumed miss model distribution p(cₑₙₜ⁽ⁱ⁾/c_{hypo}⁽ⁱ⁾) is shown in FIG. 5.

The disambiguation unit may be configured to provide disambiguation in real-time, as it may be important that word estimates are located and presented to a user as quickly as possible to minimize the user pausing during input. To expedite this search, a dictionary may be stored in one or more data structures (stored in local or remote memory, for example), enabling rapid queries of character strings similar to an entered character string. Examples of such a data structure including a k-d tree or prefix tree enable all words within a predetermined range, such as 4-6 character positions of the entered word for example, to be located. To reduce computational cost, more computationally intensive probabilistic models may be applied to only those words returned by the range query. This approach may simplify the miss model to not allow for misses of more than the predetermined range. Such a range may be configured so that the probability of entering a character outside the predetermined range is suitably negligible.

The disambiguation unit may provide both post hoc disambiguation and predictive disambiguation. One form of disambiguation is upon completion of a word, where the most likely intended word is computed based on all characters entered (post hoc disambiguation). Additionally, predictive disambiguation may disambiguate which letter was likely intended to be entered based on the ambiguous character sequence the user has already inputted, without requiring the entire word to have thus far been entered. Further, the disambiguation unit may detect when user input has been entered precisely, and in such cases not disambiguate the sequence of user input, for instance in contexts such as password entry or when some or all characters in the character sequence have been entered at a speed below a given threshold.

The disambiguation unit may further apply more complex language models where the probability of a word is evaluated not simply using that word's basic probability p(w), but the probability of that word conditioned on one or more contextual features, thereby improving the quality of estimated intended words. The impact of these contextual features on the final estimate may be weighted according to their reliability. Such features may comprise any one or more of the following: the words immediately surrounding the entered word (at a predetermined distance from the entered word) or words previously entered by the user or other users, allowing use of more complex language models such as part-of-speech or n-gram models; application context, for example on a smartphone the application in which a user is typing, or in a messaging application, the identity of the person the user is messaging. Further application context features may be provided by the application itself via an API, enabling the disambiguation unit to adapt to user habits conditioned on non-predetermined contextual features. Further contextual features may include time of day, date, geographical location, weather, user mood, brightness, etc. These features may influence word probabilities, for instance a user may be more likely to type “good morning” in the morning. Further, geography may influence word choice, for instance the names of nearby landmarks and streets may be more likely to be entered by the user.

Contextual features and behaviours may be stored on the server from time to time for each user and for all users in general, to enable disambiguation to adapt to usage patterns and tendencies for words, n-grams and other contextual information. The server may further provide backup and restoration of individual user and collective users' dictionaries and vocabularies as they are learned by the disambiguation unit.

The disambiguation unit may update probabilities according to current events and global trends, which may be obtainable from a centralized remote data store (e.g., external server). Further contextual features that may be applied comprise trends in smaller networks, such as the user's social networks, which may be applied to reweight in a fashion more relevant to the user. All of these contextual features may adapt the conditional probabilities in user-specific ways, and adapt over time to the characteristics of a particular user. For example, the disambiguation unit may store contextual information along with word information that a user enters, and process this data in order to determine which features provide information about word probabilities for that user.

The miss model applied by the disambiguation unit may further be adapted to a particular user's accuracy characteristics. Comparing a user's actual raw input, alongside their final selected input enables this miss model to be empirically determined. Higher-order language models such as n-grams may further be applied. Their use in potentially memory-constrained contexts, such as on a smartphone, may be made possible via techniques such as entropy-pruning of the models, or via compressed succinct data structures suitable for n-grams such as tries. Other data structures and processes may further reduce memory requirements by introducing a small probability of incorrect probability estimations. Such data structures include Bloom filters, compressed Bloom filters, and Bloomier filters.

Since the particular character layout shown in FIG. 9 is arranged along one dimension, the disambiguation should be transparent and comprehensible; the further away an entered letter is from the intended letter, the less likely the system is to be able to guess what was intended. Thus the character layout provided herein is selected to support disambiguation and to be transparent in functionality.

It has been found that the character layout shown in FIG. 9 provides an optimal combination of learnability, ease of disambiguation and motor efficiency, particularly when used in connection with the presently described gesture-based input. The one-dimensional layout allows each letter to have fewer adjacent characters, compared to a standard condensed two-dimensional layout such as the typical QWERTY keyboard. To design a text entry system that is robust to imprecision, the layout itself needs be as unambiguous as possible.

As in the form of a motion-sensing device accommodating sight-free text entry, the following is directed to providing word-level feedback to the user, the layout may be designed to accommodate post hoc disambiguation, where the disambiguation unit retrospectively disambiguates a character sequence at the word-level.

Thus, it has been determined that an optimal layout separates letters that are commonly interchangeable (where interchangeable words are those where a letter in one word can be replaced by another letter to form a different valid English word; the magnitude of this interchangeability is given by the frequency of occurrence of the two words). Higher-order interchangeability may also be accounted for, whereby a sequence of two or more letters in one word that can be replaced by an equally long sequence of letters to form a different valid word indicates that the letter at each position in the original sequence is interchangeable with the letter at the corresponding position in the alternate sequence, with the magnitude of this interchangeability further dependent on the likelihood of each other between-sequence pair of letters being interchanged during entry.

Commonly interchangeable letter pairs may be determined by analyzing a corpus, such as of English words. Using a corpus reduced to omit words that appear in fewer than a particular number of sources (e.g., 10 sources) and words that contain non-alphabetical characters (if the layout is only of alphabetic characters), provides an abridged corpus with associated frequencies of occurrence.

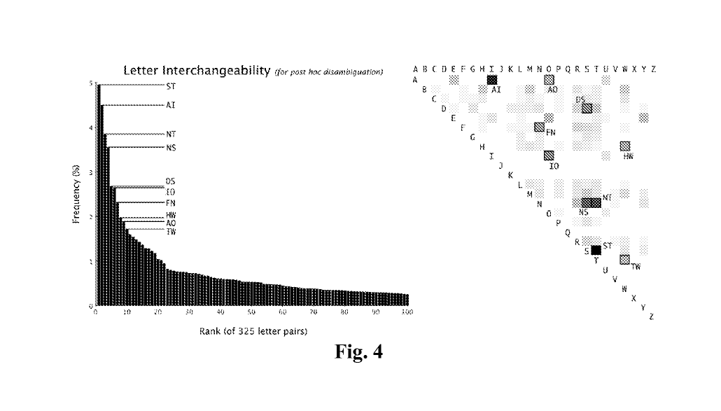

Within the abridged corpus, each word may be compared to each other word of the same length to find every pair of words that differ by only one letter. In each of these cases, the pair of letters that may ambiguously be interchanged to produce the two valid words (e.g., of the English language) may be recorded, along with an associated interchangeability score weighted by the frequency of occurrence of those words. The resulting scores across all words for each of 325 unique letter pairs from ‘A’ to ‘yz’ may be summed. FIG. 4 shows the weightings for all letter pairs, with high scores representing highly interchangeable letters that should be spaced further apart in the optimized layout A.

The unweighted cost of having ambiguous letters closer together in the layout may be determined based on the estimated miss model p(cₑₙₜ⁽ⁱ⁾/c_{hypo}⁽ⁱ⁾), shown in FIG. 5. FIG. 5(a) shows the intersection of two such distributions spaced apart by two positions producing the high (unweighted) ambiguity arising from two letters placed close together, and FIG. 5(b) shows less ambiguity arises when letters are spaced further apart.

The ambiguity cost cost_{ambig}(cᵢ,cⱼ) is unweighted by letter frequency; it is later weighted by the interchangeability function inter(cᵢ,cⱼ) to account for the relative importance of the ambiguity arising from the layout spacing of each letter pair.

Taking two miss model distributions separated by the distance between any two given letters in the layout, this ambiguity cost is defined as the intersection of those distributions, also shown in FIG. 5. This intersection may be computed for each distance, and the resulting ambiguity cost function cost_{ambig}(cᵢ,cⱼ) approximated as an exponential function, where dist(cᵢ,cⱼ) is the distance between the positions of the characters cᵢ and cⱼ in the layout:

cost_{ambig}(cᵢ,cⱼ)=exp(−0.56·dist(cᵢ,cⱼ)) (4)

Then, the function to minimize, for instance during simulated annealing (SA) optimization, involving the ambiguity cost function (4) and interchangeability score inter(cᵢ,cⱼ), is:

$${O}_{1} ( A ) = {\sum }_{i , j} {cost}_{ambig} ( {c}_{i} \vert {c}_{j} ) \cdot inter ( {c}_{i} , {c}_{j} ) \qquad ( 5 )$$

Evaluating (5) for a given layout A provides an ambiguity score for that layout.

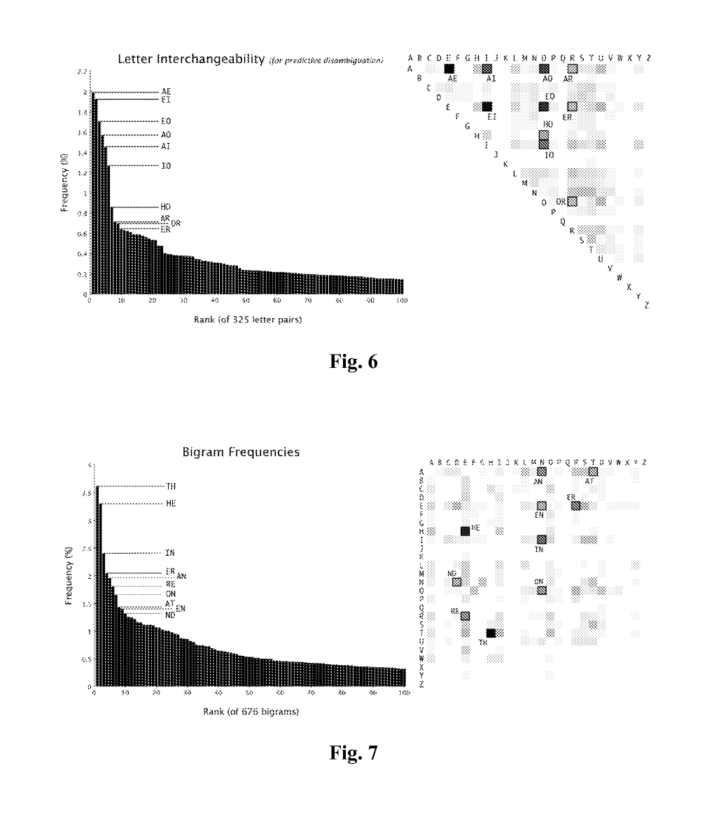

To accommodate predictive disambiguation, a different type of interchangeability may be examined, based on ambiguity of letters that are equally valid given only the sequence of letters entered thus far. A list of all word prefixes (i.e. any character sequences that, when followed by additional character(s), will constitute a valid English word) from the COCA word list may be generated along with the frequency with which each valid letter would follow each prefix. The result is a new set of scores for each letter pair representing how often they would both be valid subsequent characters when entering every word in the COCA. FIG. 6 shows these weightings, which provide the predictive interchangeability score. The predictive ambiguity cost function is then similarly found as:

$${O}_{2} ( A ) = {\sum }_{i , j} {cos}_{ambig} ( {c}_{i} \vert {c}_{j} ) \cdot {inter}_{pred} ( {c}_{i} , {c}_{j} ) \qquad ( 6 )$$

A layout A that minimizes (5) is then optimized for post hoc disambiguation, and a layout that minimizes (6) is optimized for predictive disambiguation. These objective functions may be simultaneously minimized when designing the optimized layout, which is shown as the “ENBUD” alphabet of FIG. 8, but with heavier weight on ambiguity for post hoc disambiguation.

The layout may be further optimized by minimizing a further objective function, the distance (D) required to travel when moving between letters that occupy a width (W), to reduce movement time (MT) according to Fitts' law:

$$MT = a + b \cdot {log}_{2} ( \frac{D}{W} + 1 ) \qquad ( 7 )$$

Bigram frequencies may be extracted from the corpus for all bigrams involving alphabetical characters (there are 676 in the English language, for example), to get bifreq(cᵢ,cⱼ) for cᵢ,cⱼ·ε{a, . . . , z}. Bigram frequencies are shown in FIG. 7. Treating each letter as occupying an equivalent effective width, the movement time cost is:

$${O}_{3} ( A ) = {\sum }_{i , j} bifreq ( {c}_{i} , {c}_{j} ) \cdot {log}_{2} ( dist ( {c}_{i} , {c}_{j} ) + 1 ) \qquad ( 8 )$$

The character layout may further be weighted by a heuristic function modeling empirical data that users may type letters near the middle of the layout and at the two extremes more quickly and more accurately than elsewhere. A heuristic penalty function may assign a penalty weight wᵢ to each position in the layout, with lower penalties assigned to letters in the middle of the layout and near the extremes, and lowest penalties assigned to the extremal positions. As a final optimization parameter, this heuristic penalty function may compute the cost of placing individual letters with frequencies of occurrence freq(cᵢ) (as extracted from the COCA) at each location. The function to be minimized is thus:

$${O}_{4} ( A ) = {\sum }_{i = 1}^{26} {w}_{i} \cdot freq ( {c}_{i} ) \qquad ( 9 )$$

The combined function (10) to be minimized is then the weighted sum of (5), (6), (8) and (9).

O(A)=aO₁+bO₂+cO₃+dO₄ (10)

One possible method of solving this optimization problem is by simulated annealing (SA), whereby iterating with a simulated annealing (SA) process returns a single layout that minimizes the cost function described above. However, the appropriate relative weightings a,b,c,d of the terms in (10) are initially unspecified. The weighting may be selected appropriately to support the particular needs of the user or specific implementation of the character layout.

In one example, to allow rapid text entry, post hoc disambiguation may be deemed to be the most important, followed by motor efficiency, then learnability, then predictive disambiguation. Iterating with a SA process with every combination of a small set of possible values for each term's weighting parameter may provide a plurality of possible optimized alphabets with varying tradeoffs between the parameters.

A final layout may be selected based not only on an adequate tradeoff between parameters, but also on its perceived learnability. Placement of common letters at the extremes and centre of the layout may be qualitatively determined to be beneficial to learning. Layouts that are more pronounceable and more “chunkable” may be deemed more learnable. “Chunkable” refers to the process of breaking a sequence into memorable “chunks” as described by chunking, to assist in memorization.

One example of a layout that may be deemed to provide an optimal parameter tradeoff is the ENBUD layout shown in FIG. 9, comprising the order “ENBUDJCOFLYQTHVIGMXRZPKWAS”.

To serve as a comparison, the table below shows the minimized score for each term for a variety of alternate letter layouts. ENBUD is comparable to the alphabet maximally optimized for post hoc disambiguation, but ENBUD'S improved predictive disambiguation and position heuristic scores are superior.

| | | Post Hoc | Predictive | Movement | Position |
|---|---|---|---|---|---|
| | | Disamb. | Disamb. | Efficiency | Heuristic |
| Layout (A) | Letter orderings | (O₁) | (O₂) | (O₃) | (O₄) |
| Alphabetical (A-Z) | abcdefghijklmnopqrstuvwxyz | 1.0 | 1.0 | 1.0 | 1.0 |
| QWERTY | qazwsxedcrfvtgbyhnujmikolp | 0.898 | 0.892 | 1.022 | 1.207 |
| ENBUD | enbudjcoflyqthvigmxrzpkwas | 0.449 | 0.676 | 1.046 | 0.697 |
| Ambiguity Optimized | newjprigzmxfdohqtuvlyckabs | 0.423 | 0.809 | 1.041 | 0.805 |
| Movement Optimized | zkvwgdnisathercolumpfybxjq | 1.287 | 1.499 | 0.763 | 1.441 |

The character layout may be displayed on a touchscreen interface. In this case, the layout can also be color-coded. For example, the ENBUD layout may be colour-coded to help divide it up into 5 memorable chunks, “ENBUD”, “JCOFLY”, “QTHVIG”, “MXRZP”, and “KWAS”. Distinct letters (and lines on the visual depiction of the layout) at 5 key spatial location may serve as reference markers, and correspond to distinct audio ticks heard when navigating the layout sight-free.

To alternatively support learnability, a one dimensional character layout may be formed by reducing an existing two-dimensional character layout such as the QWERTY keyboard to a single dimension, for example yielding the sequence QAZWSXEDCRFVTGBYHNUJMIKOLP. Given the variety of ways to reduce a two-dimensional layout to a single dimension, the precise arrangement of letters may be further refined to optimize the layout to minimize any of the terms (5), (6), (8), and (9). Other conventional keyboard layouts, including two-dimensional keyboard layouts, such as those used other languages, may similarly be reduced to a single dimension in the same manner.

An alternate one dimensional character layout is the alphabetical layout “ABCDEFGHIJKLMNOPQRSTUVWXYZ”.

An example of a gesture or movement based input is now described. In an example of the input unit receiving information based on movement of the device, a user may select a character by orienting the mobile device in a particular way and executing a particular command. For example, the user may turn the mobile device in their hand to the orientation corresponding to the desired character prior to tapping anywhere on the screen with their thumb to enter that character.

The presently described gesture-based input is adapted to utilize the level of precision in sensing made possible by a gyroscope, and by the potential benefits of leveraging users' proprioceptive awareness of a mobile device's orientation held in their hand or on their body. Proprioception is the sense of the position and movements of the body.

The input unit maps characters to specific preconfigured points along a rotational dimension. In an example, a user holding a mobile device naturally moves that device about a rotational axis by the movement of his or her wrist. While standard mobile touchscreen typing involves positioning relative to the screen location, wrist rotation involves positioning relative to the direction of gravity, which can be experienced without visual feedback.

The input unit senses, by use of the gyroscope, the relative position of the mobile device during input. A predefined gesture may be allocated to a confirmation of the character to be entered. Thus, in one example, the user ‘points’ the device in the direction of the desired letter and can tap anywhere on the screen with their thumb.

The preconfigured points along the rotational dimension may, in an example, be set out along a total angular extent of 125°, which corresponds to the average range of motion (ROM) of the wrist under pronation/supination (as shown roughly in FIG. 2). The predetermined points may be spaced at equal angular increments along the extent, or may be spaced at unequal angular increments. In one embodiment, the characters corresponding to the 26 characters of the English alphabet may be spaced quadratically, spacing letter targets in the centre of the layout (where the wrist can conduct more precise actions) closer together, for example as close as 4.3° apart, while letters at the extreme edges of the layout are spaced further apart, for example up to 6.2° apart. In practice, a user may quickly set the desired rotational extent based on their personal ROM by performing an initial calibration involving turning the device to the comfortable extremes.

Although a gyroscope may enable a small target size to be readily distinguished by the device, by Fitts' law this small target size for a selection task may hinder rapid text entry. However, through knowledge of the input language, and with prior estimation of a miss model, modelling how much users typically miss their target, the input unit may enable users to aim within a few letters (e.g., ±2 letters, an effective target size of 25°) with the disambiguation unit disambiguating the intended word, allowing rapid text entry when entering words stored in a dictionary of possible words (which may be expanded throughout use as custom words are entered). Users may choose to be more precise when they wish by slowing down, especially when perceiving that the word to be entered is unusual or otherwise unlikely to be selected as the primary candidate by the disambiguation process. In addition, for either movement-based input or any other input modality, the disambiguation unit may use temporal information about the rate of character selection to variably interpret the ambiguity of each entered character. The system can thus be said to provide variable ambiguity that is lacking in text input systems that make use of discrete disambiguation (e.g. T9, where characters are grouped into discrete selectable units). By using continuous ambiguous input the system has higher resolution information about user target selection for better-informed disambiguation.

Additionally, the input unit senses, by use of the accelerometer, the acceleration of the mobile device. The use of the combination of the gyroscope/accelerometer measurements enables the input unit to isolate user acceleration from acceleration due to gravity, thus enabling device orientation to be determined without interference caused by user motion. When a user grips the mobile device in their right hand, for example, the wrist motions of pronation and supination cause the device to turn between ‘pointing’ to the left, with the screen facing downwards, and ‘pointing’ to the right, with the screen facing upwards. The detection of this component of orientation is robust to a wide range of ways of holding the device.

The input unit may further apply the measurements from the gyroscope and/or accelerometer to apply one or more gestures to one or more corresponding predetermined inputs. Alternatively, or in addition, gestures provided using the touchscreen (such as a tap, swipe, pinch, etc. of the touchscreen) may be used for input.

Gestures made using the device comprise flicking the device around various axes, and may be used to perform actions such as space, enter, character-level backspace and word-level backspace. Forward and backwards cycling may serve dual-purposes, acting as both a space gesture and a disambiguation gesture; cycling forwards or backwards with these motions may navigate the user through a list of candidate words. For example, once a string of letters has been entered, a forward flick replaces the entered string with a disambiguated string appended with a space. The disambiguated word may be the first in the list of 10 possible candidate words, along with a 0th word, corresponding to the original typed string. Subsequent forward cycles would not enter another space, but instead replace the entered word with the next word in the candidate list. Subsequent backward cycles may similarly replace the entered word with the previous word in the candidate list.

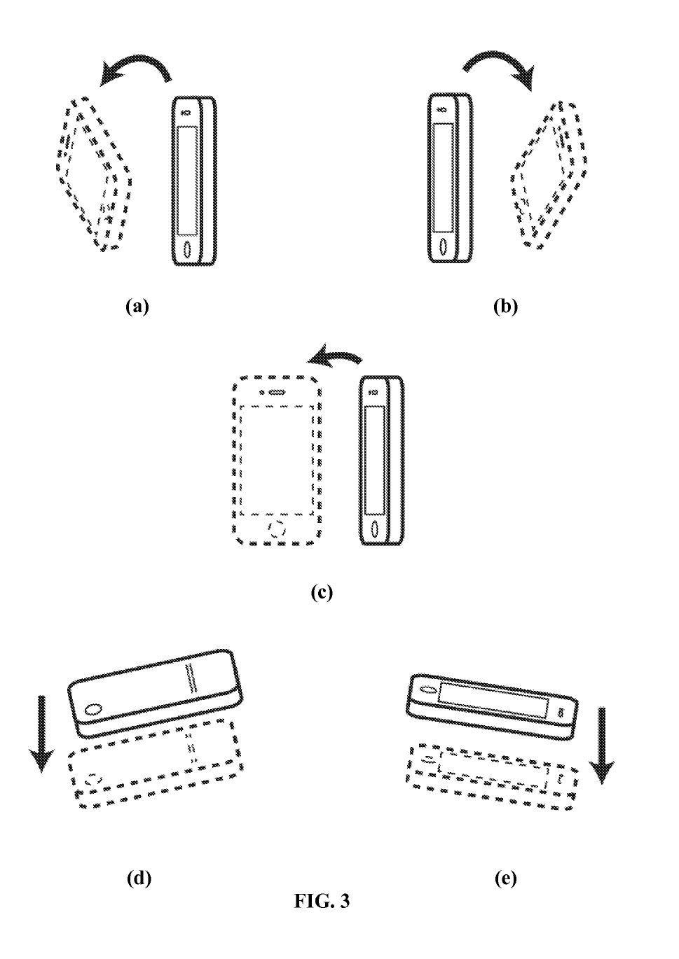

In an example, the following gestures may provide the following inputs: a forward flick, shown in FIG. 3(a), corresponds to “space/cycle”, which types a space (after a concluded word) and/or chooses the next most likely candidate word (during input of a word); a backward flick, shown in FIG. 3(b), corresponds to “back cycle”, which types a space (after a concluded word) and/or chooses the previous candidate word (during input of a word); a left swing, shown in FIG. 3(c), corresponds to “backspace, which deletes a single character; a screen-down drop, shown in FIG. 3(d), corresponds to “word backspace”, which deletes an entire word; and a screen-up drop, shown in FIG. 3(e), corresponds to “enter”, which concludes the phrase. The space and backspace gestures can be performed at any device orientation. As such, having these interactions as gestures instead of as targets alongside letters allows them to be performed more rapidly. This is particularly useful because 36% of all bigrams (in the Corpus of Contemporary American English (COCA)) involve a space.

The input unit may output, using the speaker, one or more sounds corresponding to inputs made by the user for the purposes of feedback and confirmation. Audio feedback can be provided for any or every gesture performed, any or every word entered, and any or all navigation within the rotational input space. For example, a click/tick sound can be used to indicate to a user the traversing of a character. To promote awareness of location in the alphabet along as many perceptual dimensions as possible, the ticks may be both spatialised and pitch-adjusted to sound at a lower pitch and more in the left ear when the device passes orientations corresponding to characters in the left-hand side of the alphabet, and at a higher pitch and more in the right ear when the device passes by character locations on the right-hand side of the alphabet. It will be appreciated that the low pitch and high pitch can be switched, that the sounds can vary as low-high-low and high-low-high, or other pattern, or the variation can be made using volume, another audio feedback mechanism or other haptic feedback mechanism. Alternatively, the character can be read aloud as the device is at an angle selecting it.

Additionally, distinctive sounds can be allocated to reference points along the dimension (e.g., five letter locations at key intervals) enabling the user to reorient themselves. Unique confirmatory sounds may correspond to each other gesture, and disambiguation of a word (with a forward or backward flick) may additionally result in that word being spoken aloud.

The input unit may also provide a refined selection mode. When a user wants to be more precise in choosing a letter, she may be provided with two options: she can slow down and listen/count through the ticks that she hears, using the reference points as a reference; or she can imprecisely move toward the general vicinity of the desired letter as usual but tap to perform a predetermined gesture, such as holding her thumb down on the screen. While the thumb is held down, rotational movement can cease to modify the character selection, and after holding for a predetermined period, for example 300 ms, the device can enter a refined selection mode in which the letter that was selected is spoken aloud. The user can then slide her thumb up and down on the screen (or perform another gesture on the screen or with respect to the device) to refine the letter selection, with each letter passed spoken along the way. Whatever letter was last spoken when she released her thumb may be the letter entered. If she has touched at an orientation far away from where she intends to go, she can simply slide the thumb off the screen (or other gesture) to cancel the precise mode selection. This mode can be used to ensure near perfect entry when entering non-standard words. Non-standard words entered using this method may be added to the word list used by the disambiguation unit to improve future disambiguation.

Similarly, in an embodiment wherein a virtual keyboard appears on the touchscreen interface, the input unit may display a magnification view of the keyboard. In an example, a user may hold on a specific point of the keyboard for a brief or extended period of time, say 100 or more milliseconds, after which that portion of the keyboard (the character at that point along with a predetermined number of adjacent characters, say 1 or 2 to the left and right) appear above the characters in a magnified view. The user may then slide her finger upward to select one of the magnified characters, enabling more accurate selection. The user may further slide her finger upward and then left or right to move the magnification to another portion of the keyboard.

An auxiliary magnification view may instead provide a magnification of the text that has been previously entered, for example centered around the current cursor location. This magnified view of the cursor location may then be used to rapidly adjust the cursor location, for reduced effort with fine-grained selection and manipulation of previously input text. Such a magnification view could, in an example, appear directly above the keyboard, with the screen space for such a view being especially enabled by the otherwise minimized vertical dimension of the keyboard.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A system for enabling a user to provide input to a computer, the system comprising:
(a) an input unit operable to obtain one or more user input from said user and map each said user input to a coordinate along a one-dimensional input space; and
(b) a disambiguation unit operable to apply continuous disambiguation along said one-dimensional input space to generate an output corresponding to the user input.

2. The system of claim 1, wherein said input space is selected from a fully continuous dimension and a continuous dimension comprising a separated plurality of continuous segments.

3. The system of claim 1, wherein said one-dimensional input space comprises a non-linear dimension parameterized along a one-dimensional manifold.

4. The system of claim 1, wherein the disambiguation unit applies information about said coordinates along a second dimension.

5. The system of claim 1, wherein said one-dimensional input space comprises a finite number of characters and said continuous disambiguation comprises disambiguation based upon specific points of said coordinates corresponding to said user input.

6. The system of claim 1, wherein said disambiguation unit is provided with access to one or more corpora of text which are referenced during disambiguation.

7. The system of claim 6, wherein the disambiguation unit applies a maximum a posteriori (MAP) disambiguation process.

8. The system of claim 6, wherein said disambiguation process comprises conditioning the output based on one or more contextual features.

9. The system of claim 8, wherein said contextual features comprise any one or more of the following: words surrounding an entered word corresponding to the user input, words previously entered by the user, application context, time of day, date, geographical location, weather, user mood, and brightness.

10. The system of claim 5, wherein said characters are arranged along said one-dimensional input space by optimizing an objective function comprising one or more of assigning a weight to each of motor efficiency, predictive disambiguation and post hoc disambiguation.

11. (canceled)

12. (canceled)

13. (canceled)

14. (canceled)

15. (canceled)

16. (canceled)

17. (canceled)

18. (canceled)

19. A method for enabling a user to provide input to a computer, the method comprising:
(a) obtaining one or more user input from said user;
(b) mapping each said user input to a coordinate along a one-dimensional input space; and
(c) generating an output corresponding to the user input by applying, using one or more processors, continuous disambiguation along said one-dimensional input space.

20. The method of claim 19, wherein said input space is selected from a fully continuous dimension and a continuous dimension comprising a separated plurality of continuous segments.

21. The method of claim 19, wherein said one-dimensional input space comprises a non-linear dimension parameterized along a one-dimensional manifold.

22. The method of claim 19, further comprising applying information about said coordinates along a second dimension.

23. The method of claim 19, wherein said one-dimensional input space comprises a finite number of characters and said continuous disambiguation comprises disambiguation based upon specific points of said coordinates corresponding to said user input.

24. The method of claim 19, further comprising referencing one or more corpora of text during disambiguation.

25. The method of claim 24, wherein said disambiguation comprises applying a maximum a posteriori (MAP) disambiguation process.

26. The method of claim 24, wherein said disambiguation process comprises conditioning the output based on one or more contextual features.

27. The method of claim 26, wherein said contextual features comprise any one or more of the following: words surrounding an entered word corresponding to the user input, words previously entered by the user, application context, time of day, date, geographical location, weather, user mood, and brightness.

28. The method of claim 23, further comprising arranging said characters along said one-dimensional input space by optimizing an objective function comprising one or more of assigning a weight to each of motor efficiency, predictive disambiguation and post hoc disambiguation.

29. (canceled)

30. (canceled)

31. (canceled)

32. (canceled)

33. (canceled)

34. (canceled)

35. (canceled)

36. (canceled)
